(19) United States
(12) Patent Application Publication
(10) Pub. No.: US 2016/0062983 A1
(43) Pub. Date: Mar. 3, 2016

(54) ELECTRONIC DEVICE AND METHOD FOR RECOGNIZING NAMED ENTITIES IN ELECTRONIC DEVICE

(71) Applicant: Samsung Electronics Co., Ltd., Suwon-si (KR)

(72) Inventors: Seok-Yeong JUNG, Yongin-si (KR); Kyung-Tae KIM, Hwaseong-si (KR)

(21) Appl. No.: 14/843,464

(22) Filed: Sep. 2, 2015

(30) Foreign Application Priority Data
Sep. 2, 2014 (KR) 10-2014-0115911

(51) Int. Cl. G06F 17/27; G10L 15/26

(52) U.S. Cl. CPC G06F 17/278; G10L 15/26; G06F 17/2755

(57) ABSTRACT

A method for operating an electronic device is provided. The method includes analyzing text to recognize at least one named entity, compare the recognized at least one named entity with at least one piece of reference information to determine the similarity, as a result of the determination, selecting at least one piece of reference information of which the similarity with respect to the recognized at least one named entity is greater than or equal to a reference value, and executing a predetermined function, based on the selected at least one piece of reference information.

### CROSS-REFERENCE TO RELATED APPLICATION(S)

This application claims the benefit under 35 U.S.C. §119(a) of a Korean patent application filed on Sep. 2, 2014 in the Korean Intellectual Property Office and assigned Serial number 10-2014-0115911, the entire disclosure of which is hereby incorporated by reference.

### TECHNICAL FIELD

The present disclosure relates to an electronic device and a method for recognizing named entities in an electronic device.

### BACKGROUND

Currently, various speech recognition methods have been provided. For example, there is a method of recognizing predetermined and specific words, and one of the methods for the speech recognition creates templates for specific words and compares the same with a speech input. In this case, the speech input is not transformed into text in the recognition process, and a recognizing engine may not recognize the meaning of each word.

In another implementation of the method for the speech recognition, the speech input may be recognized as a phoneme unit or an equivalent thereto, and may be transformed into text.

The above information is presented as background information only to assist with an understanding of the present disclosure. No determination has been made, and no assertion is made, as to whether any of the above might be applicable as prior art with regard to the present disclosure.

### SUMMARY

The speech recognition method only by using predetermined words has a high recognition rate and is less affected by interference, whereas the method cannot react to the words other than the predetermined words, so that the usability thereof is relatively low. A natural language recognition system processes all of natural language inputs as well as predetermined user inputs to thereby perform a predetermined function. However, since the pronunciation of named entities, such as names, company names, or addresses, are often unique, compared with general words or phrases, the recognition rate thereof may decrease.

Aspects of the present disclosure are to address at least the above-mentioned problems and/or disadvantages and to provide at least the advantages described below. Accordingly, an aspect of the present disclosure is to provide an electronic device and a method for recognizing named entities in an electronic device, for example, which compare at least one named entity recognized from text with at least one piece of reference information in order to thereby enhance the recognition rate with respect to incorrectly pronounced named entities.

In accordance with an aspect of the present disclosure, an electronic device is provided. The electronic device includes a memory that stores at least one piece of reference information, and a controller that analyzes text to recognize at least one named entity, compares the recognized at least one named entity with at least one piece of reference information to determine the similarity, as a result of the determination, selects at least one piece of reference information of which the similarity with respect to the recognized at least one named entity is greater than or equal to a reference value, and executes a predetermined function, based on the selected at least one piece of reference information.

In accordance with another aspect of the present disclosure, a method for operating an electronic device is provided. The electronic device includes analyzing text to recognize at least one named entity, comparing the recognized at least one named entity with at least one piece of reference information to determine the similarity, selecting, as a result of the determination, at least one piece of reference information of which the similarity with respect to the recognized at least one named entity is greater than or equal to a reference value, and executing a predetermined function, based on the selected at least one piece of reference information.

According to various embodiments of the present disclosure, the electronic device and the method for recognizing named entities in the electronic device may compare at least one named entity recognized from text with reference information (e.g., call log information) in order to thereby enhance the recognition rate with respect to a desired named entity, even though the user incorrectly pronounces the named entity.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a network environment according to an embodiment of the present disclosure;

FIG. 2 illustrates an example of a configuration of a natural language recognition module according to an embodiment of the present disclosure;

FIG. 3 is a flowchart illustrating an operation of an electronic device according to an embodiment of the present disclosure;

FIG. 4 is a flowchart illustrating an operation of recognizing named entities in an electronic device according to various embodiments of the present disclosure;

FIG. 5 is a flowchart illustrating an operation of recognizing named entities in an electronic device according to various embodiments of the present disclosure;

FIG. 6 is a flowchart illustrating an operation of recognizing named entities in an electronic device according to various embodiments of the present disclosure;

FIG. 7 illustrates a functional block diagram of an electronic device according to various embodiments of the present disclosure;

FIG. 8 illustrates a functional block diagram of an electronic device according to various embodiments of the present disclosure;

FIG. 9 illustrates a functional block diagram of an electronic device according to various embodiments of the present disclosure;

FIG. 10 illustrates an example of processing a speech input in an electronic device according to various embodiments of the present disclosure;

FIG. 11 is a detailed block diagram of an electronic device according to an embodiment of the present disclosure; and

FIG. 12 is a block diagram of a program module according to various embodiments of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the present disclosure, the expression “have”, “may have”, “include” or “may include” refers to existence of a corresponding feature (e.g., numerical value, function, operation, or components such as elements), and does not exclude existence of additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” may include (1) at least one A, (2) at least one B, or (3) both at least one A and at least one B.

The expression “a first”, “a second”, “the first”, or “the second” used in various embodiments of the present disclosure may modify various components regardless of the order and/or the importance but does not limit the corresponding components. The above expressions are used merely for the purpose of distinguishing an element from the other elements. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

As used herein, the expression “configured to” may be interchangeably used with the expression “suitable for”, “having the capability to”, “designed to”, “adapted to”, “made to”, or “capable of”. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations or a generic-purpose processor (e.g., central processing unit (CPU) or application processor (AP)) that may perform the corresponding operations by executing one or more software programs stored in a memory device.

Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

For example, the electronic device may include at least one of a smartphone, a tablet personal computer (PC), a mobile phone, a video phone, an electronic book (e-book) reader, a desktop PC, a laptop PC, a netbook computer, a personal digital assistant (PDA), a portable multimedia player (PMP), a Moving Picture Experts Group (MPEG-1 or MPEG-2) audio layer 3 (MP3) player, a mobile medical appliance, a camera, and a wearable device (e.g., a head-mounted-device (HMD) such as electronic glasses, electronic clothes, an electronic bracelet, an electronic necklace, an electronic appcessory, electronic tattoos, or a smart watch).

According to various embodiments of the present disclosure, the electronic device may be a smart home appliance. The home appliance may include at least one of, for example, a television (TV), a digital versatile disc (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

According to an embodiment of the present disclosure, the electronic device may include at least one of various medical devices (e.g., various portable medical measuring devices (a blood glucose monitoring device, a heart rate monitoring device, a blood pressure measuring device, a body temperature measuring device, etc.), a magnetic resonance angiography (MRA), a magnetic resonance imaging (MRI), a computed tomography (CT) machine, and an ultrasonic machine), a navigation device, a global positioning system (GPS) receiver, an event data recorder (EDR), a flight data recorder (FDR), a vehicle infotainment devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or Internet device of things (e.g., a light bulb, various sensors, electric or gas meter, a sprinkler device, a fire alarm, a thermostat, a streetlamp, a toaster, a sporting goods, a hot water tank, a heater, a boiler, and the like).

According to various embodiments of the present disclosure, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device according to various embodiments of the present disclosure may be a combination of one or more of the aforementioned various devices. The electronic device according to various embodiments of the present disclosure may be a flexible device. Further, the electronic device according to an embodiment of the present disclosure is not limited to the aforementioned devices, and may include a new electronic device according to the development of technology

The term “named entity” may refer to a noun that has a single attribute in the various embodiments of the present disclosure. For example, the named entities may refer to words, such as a person's name, an organization's name, the title of a song, a broadcasting name, or a place name, or a group thereof.

Hereinafter, an electronic device according to various embodiments of the present disclosure will be described with reference to the accompanying drawings. As used herein, the term “user” may indicate a person who uses an electronic device or a device (e.g., an artificial intelligence electronic device) that uses an electronic device.

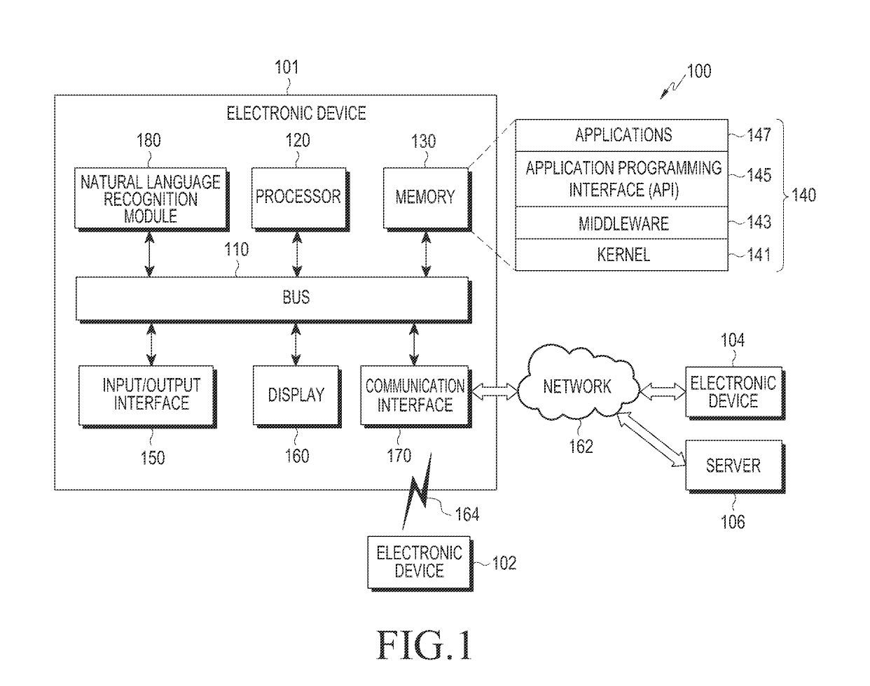

FIG. 1 illustrates a network environment according to an embodiment of the present disclosure.

Referring to FIG. 1, according to various embodiments of the present disclosure, the electronic device 101 in the network environment 100 is disclosed. The electronic device 101 may include at least one of a bus 110, a processor 120, a memory 130, an input/output interface 150, a display 160, a communication interface 170, or a natural language recognition module 180. In an embodiment of the present disclosure, the electronic device 101 may exclude some of the elements, or may further include other elements.

The bus 110 may be a circuit for connecting elements 110, 120, 130, 140, 150, 160, 170 and 180 with each other and transferring communication data (e.g., control messages and/or data) between the elements.

The processor 120 may include one or more of a CPU, an AP, or a communication processor (CP). The processor 120, for example, may process calculation or data in relation to the control and/or communication with respect to one or more of the elements of the electronic device 101.

The memory 130 may include a volatile memory and/or a non-volatile memory. The memory 130, for example, may store instructions or data related to at least one element of the electronic device 101. According to an embodiment of the present disclosure, the memory 130 may include software and/or programs 140. The programs 140, for example, may include a kernel 141, a middleware 143, an application programming interface (API) 145, and/or application programs (or applications) 147. At least some of the kernel 141, the middleware 143, or the API 145 may be referred to as an operating system (OS).

The kernel 141 may control or manage system resources (e.g., the bus 110, the processor 120, the memory 130, or the like) that are used in performing operations or functions implemented by other programs (e.g., the middleware 143, the API 145 or the application programs 147). Further, the kernel 141 may provide an interface by which the middleware 143, the API 145 or the application programs 147 may access each element of the electronic device 101 in order to thereby control or manage system resources.

The middleware 143, for example, may play an intermediate role between the API 145 or the application programs 147 and the kernel 141 to communicate with each other for transmission and reception of data. Furthermore, in relation to requests for an operation received from the application programs 147, the middleware 143, for example, may control (e.g., scheduling or load-balancing) the requests, for example, by giving the priority for using system resources (e.g., the bus 110, the processor 120, the memory 130, or the like) of the electronic device 101 to at least one of the application programs 147.

The API 145, for example, may be an interface by which the applications 147 control functions provided from the kernel 141 or the middleware 143, and may include, for example, at least one interface or function (e.g., instructions) for file control, window control, image processing, or text control.

The input/output interface 150 may transfer instructions or data input from the user or external devices to other elements of the electronic device 101. In addition, the input/output interface 150 may output instructions or data input from other elements of the electronic device 101 to the user or the external devices.

The display 160 may include, for example, a liquid crystal display (LCD), a light emitting diode (LED) display, an organic LED (OLED) display, a micro-electromechanical system (MEMS) display, or an electronic paper display. The display 160 may display various pieces of content (e.g., text, images, videos, icons, or symbols) to the user. The display 160 may include a touch screen, and for example, may receive an input of a touch, a gesture, proximity, or a hovering by using an electronic pen or a user's body part.

The communication interface 170, for example, may perform communication connection between the electronic device 101 and external devices (e.g., a first external electronic device 102, a second external electronic device 104, a server 106, and the like). For example, the communication interface 170 may be connected to a network 162 through wireless communication or wired communication to thereby communicate with the external device (e.g., the second external electronic device 104, or the server 106)

The wireless communication, for example, may use at least one of long term evolution (LTE), LTE-advanced (LTE-A), code division multiple access (CDMA), wideband CDMA (WCDMA), universal mobile telecommunications system (UMTS), wireless broadband (WiBro), or global system for mobile communication (GSM). The wired communication may include at least one of a universal serial bus (USB), a high definition multimedia interface (HDMI), recommended standard 232 (RS-232), or a plain old telephone service (POTS). The network 162 may include at least one of telecommunication networks, such as, for example, computer networks (e.g., local-area network (LAN) or wide area network (WAN)), the Internet, or a telephone network.

The first and the second external electronic devices 102 and 104 may be the same device as the electronic device 101, or different devices from the same. According to an embodiment of the present disclosure, the server 106 may include a group of one or more servers.

According to various embodiments of the present disclosure, some of or all of the operations executed by the electronic device 101 may be performed by one or more other electronic devices (e.g., the external electronic devices 102 and 104, or the server 106). According to an embodiment of the present disclosure, when the electronic device 101 executes some functions or services automatically or by a user's request, the electronic device 101 may make a request to other devices (e.g., the external electronic devices 102 and 104, or the server 106) for the execution of at least some of the related functions instead of or in addition to the execution of the functions or services by the electronic device 101. The other devices (e.g., the external electronic devices 102 and 104, or the server 106) may execute the requested functions or additional functions, and may transfer the result thereof to the electronic device 101. The electronic device 101 may provide the requested function or service by using the received result or by further processing the result. To this end, for example, cloud computing, distributed computing, or client-server computing may be utilized.

Although the electronic device 101 adopts the communication interface 170 and communicates with the external electronic device 104 or the server 106 through the network 162 in FIG. 1, according to various embodiments of the present disclosure, the electronic device 101 may be configured to operate independently without a separate communication function.

According to an embodiment of the present disclosure, the server 106 may perform at least one of the operations (or functions) executed by the electronic device 101 in order to thereby support the electronic device 101. For example, the server 106 may include a natural language recognition processing server module (not shown) to support the natural language recognition module 180 of the electronic device 101. For example, the natural language recognition processing server module may include at least one element of the natural language recognition module 180, and may perform at least one of the operations (or functions) executed by the natural language recognition module 180.

The natural language recognition module 180 may process some of the information received from other elements (e.g., the processor 120, the memory 130, the input/output interface 150, or the communication interface 170), and may provide the same to the user in various ways.

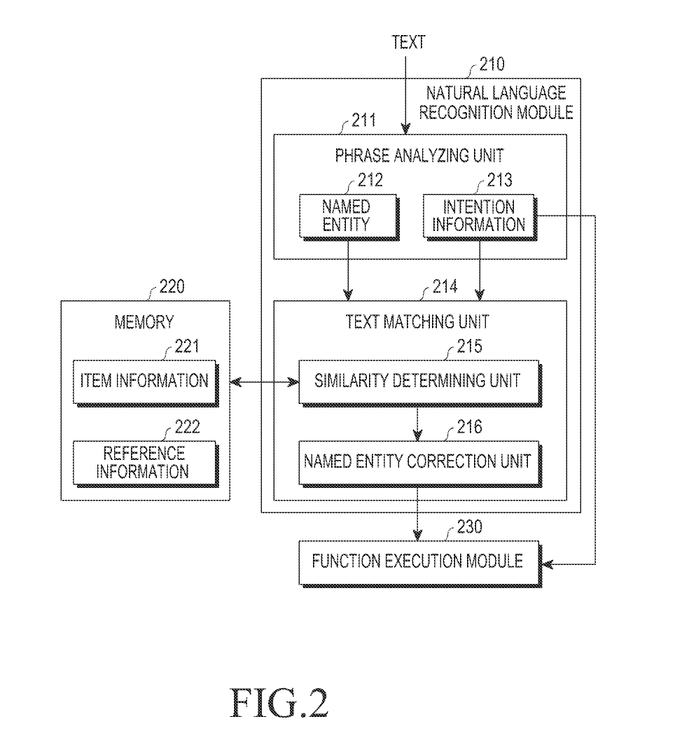

For example, the natural language recognition module 180, according to various embodiments of the present disclosure, may: transform a speech input received through a microphone (not shown) connected with the input/output interface 150 into text; recognize at least one named entity from the transformed text; and compare the recognized named entity with reference information, which is stored in the memory 130 or created, to thereby enhance the recognition rate of the named entity. The natural language recognition module 180 will be described in more detail with reference to FIG. 2 below.

Although the natural language recognition module 180 is illustrated separately from the processor 120 in FIG. 1, at least some elements of the natural language recognition module 180 may be included in the processor 120 or at least one of other modules, and the natural language recognition module 180 may be configured such that all of the functions thereof are included in the processor 120 or another processor.

FIG. 2 illustrates a block diagram of an electronic device (e.g., a natural language recognition module 180 of the electronic device 101) according to various embodiments of the present disclosure. For convenience of explanation, the description will be made of an example in which the natural language recognition module 180 is operated in the processor 120. At least one element included in the natural language recognition module may be included in the natural language recognition module 180 or the processor 120 of FIG. 1.

Referring to FIG. 2, the electronic device 101 may include at least one of a natural language recognition module 210, a memory 220, or a function execution module 230. In addition, the electronic device 101 may further include a microphone or a speaker, according to various embodiments of the present disclosure.

According to various embodiments of the present disclosure, the natural language recognition module 210 may include at least one of a phrase analyzing unit 211 or a text matching unit 214.

The phrase analyzing unit 211 of the natural language recognition module 210 may phrase-analyze (e.g., parse) input text to thereby recognize at least one named entity 212 included in the text. In addition, according to various embodiments of the present disclosure, the phrase analyzing unit 211 may phrase-analyze the text to further recognize user's intention information 213.

The text matching unit 214 of the natural language recognition module 210 may include at least one of a similarity determining unit 215 or a named entity correction unit 216.

The similarity determining unit 215 may compare at least one named entity recognized through the phrase analyzing unit 211 with at least one piece of reference information 222 stored in the memory 220 in order to thereby determine the similarity. The similarity determining unit 215 may determine the similarity using various algorithms. For example, a “Levenshtein distance” algorithm may be applied as described later, but the present disclosure is not limited to a specific algorithm.

The named entity correction unit 216 may determine whether or not the named entity is to be corrected based on the result of the similarity determination by the similarity determining unit 215. For example, if the similarity between the named entity and the reference information is greater than or equal to a reference value as a result of the similarity determination, the named entity correction unit 216 may correct the corresponding named entity as the reference information of which the similarity is greater than or equal to the reference value. According to various embodiments of the present disclosure, in the case of a plurality of pieces of reference information of which the similarity is greater than or equal to the reference value, the reference information that has a highest similarity may be selected as the reference information to be corrected, or all of pieces of reference information, of which the similarity is greater than or equal to the reference value, may be selected.

The function execution module 230 may execute a predetermined function, based on the named entity that has been corrected as the reference information of which the similarity is greater than or equal to the reference value.

According to various embodiments of the present disclosure, the predetermined function in the function execution module 230 may be related to the user's intention information recognized by the phrase analyzing unit 211. For example, when the intention information “Call” is recognized as a result of the phrase-analyzing of the input text, the function execution module 230 may execute at least one function related to a phone call, based on the recognized named entity (or the corrected named entity using the reference information).

The memory 220 may include at least one of item information 221 or reference information 222. According to various embodiments of the present disclosure, the reference information 222 may be mapped with one or more pieces of the item information 211 to then be stored. In addition, the reference information 222 may be classified into any one of a plurality of pieces of the item information 221 to then be stored.

For example, the item information 221 may be items (e.g., a phone call, messages, or the like) related to the functions of a smart phone, or may be items related to at least one application installed in the smart phone. According to various embodiments of the present disclosure, in the case where the item information 221 is “a phone call,” the reference information 222, which is stored to correspond to the item, may be the information related to a phone call, i.e., contact information or call log information, which are stored in the smart phone.

According to various embodiments of the present disclosure, in the case where the input text is “Call Ki Myeon Moon,” the phrase analyzing unit 211 may recognize “Ki Myeon Moon” as the named entity 211, and “Call” as the intention information 213. The text matching unit 214 may compare “Ki Myeon Moon” recognized as the named entity 212 with at least one piece of reference information 222 stored in the memory 220 to determine the similarity. For example, as a result of the determination, if the reference information 222 includes “Ki Myeon Moon,” the recognized “Ki Myeon Moon” may be determined to be the final named entity without correction thereof. In addition, as a result of the determination, if the reference information 222 does not include “Ki Myeon Moon,” and “Kim Hyeong Moon” is identified as the reference information of which the similarity is greater than or equal to the reference value, the named entity may be corrected as the identified “Kim Hyeong Moon.”

In addition, according to various embodiments of the present disclosure, as “Call” is recognized as the intention information 213 set forth above, one of a call log or a contact list of the item information 221, which are related to a call, may be used as the reference information. For example, if “Ki Myeon Moon” is not recorded in the user's call log, but “Kim Hyeong Moon” is discovered, which has a highest similarity with respect to “Ki Myeon Moon,” the named entity may be changed from “Ki Myeon Moon” into “Kim Hyeong Moon” to then execute a related function. According to the result of the embodiment, the function execution module 230 may make a call to a contact number corresponding to “Kim Hyeong Moon”, which is stored in the call log information.

According to various embodiments of the present disclosure, category information on the named entity recognized above may be used as the reference information. For example, the category of the recognized named entity corresponds to location information, such as “Gangnam,” the similarity may be determined by using the reference information related to the location.

According to various embodiments of the present disclosure, an electronic device may include: a memory that stores at least one piece of reference information; and a controller that analyzes text to recognize at least one named entity, compares the recognized named entity with at least one piece of reference information to determine the similarity, as a result of the determination, selects at least one piece of reference information of which the similarity with respect to the recognized named entity is greater than or equal to a reference value, and executes a predetermined function, based on the selected reference information.

According to various embodiments of the present disclosure, the controller further makes a control to transform a speech signal input through a microphone into text.

According to various embodiments of the present disclosure, the controller further makes a control to phrase-analyze the text to thereby recognize at least one piece of intention information, and the reference information is information corresponding to the item related to the recognized intention information, or information corresponding to the category of the recognized named entity.

According to various embodiments of the present disclosure, the reference information is call log information stored in the electronic device.

According to various embodiments of the present disclosure, the controller further makes a control to renew the reference value, based on the user's reaction to the predetermined function.

According to various embodiments of the present disclosure, the renewing of the reference value comprises increasing or decreasing a previously configured reference value by a predetermined unit.

According to various embodiments of the present disclosure, the predetermined unit is determined according to at least one of using time, the frequency of use, or the number of pieces of the selected reference information.

According to various embodiments of the present disclosure, the controller further makes a control to create a pronunciation transformation rule, based on the user's reaction to the predetermined function.

According to various embodiments of the present disclosure, the created pronunciation transformation rule is applied to the determination of the similarity.

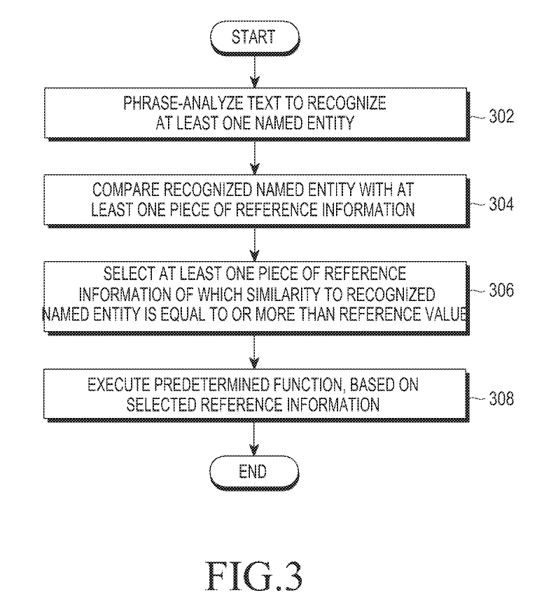

FIG. 3 is a flowchart illustrating an operation of an electronic device according to an embodiment of the present disclosure.

Referring to FIG. 3, in operation 302, the electronic device 101 may phrase-analyze the text to recognize at least one named entity. In operation 304, the electronic device 101 may compare at least one recognized named entity with at least one piece of reference information.

In operation 306, as a result of comparing the recognized named entity with the at least one piece of the reference information, the electronic device 101 may select at least one piece of the reference information of which the similarity is greater than or equal to the reference value. According to various embodiments of the present disclosure, in the case of a plurality of pieces of reference information of which the similarity is greater than or equal to the reference value with respect to a specific named entity, the electronic device 101 may select one piece of reference information that has a highest similarity, or may select two or more pieces of reference information of which the similarity is greater than or equal to the reference value. In addition, in the case where a plurality of pieces of reference information is selected, the electronic device 101 may sort the plurality of pieces of reference information into similarity order, or may give the priority thereto.

The selection of the reference information, according to the result of the analysis of the similarity, may mean the operation of correcting the corresponding named entity as the selected reference information, or the operation of replacing the corresponding named entity with the selected reference information.

In operation 308, the electronic device 101 may execute a predetermined function, based on the selected reference information (or the corrected or replaced named entity).

At least one of the operations illustrated in FIG. 3 may be omitted, or at least one other operation may be added between the operations. In addition, the operations may be sequentially processed as illustrated in FIG. 3, and the execution sequence of at least one operation may be switched with that of another operation. Furthermore, the operations illustrated in FIG. 3 may be performed in the electronic device 101 or a server 106. At least one of the operations illustrated in FIG. 3 may be performed within the electronic device 101 and the remaining operations may be performed by the server 106.

According to various embodiments of the present disclosure, a method for operating an electronic device may include: analyzing text to recognize at least one named entity; comparing the recognized named entity with at least one piece of reference information to determine the similarity; as a result of the determination, selecting at least one piece of reference information of which the similarity with respect to the recognized named entity is greater than or equal to a reference value; and executing a predetermined function, based on the selected reference information.

According to various embodiments of the present disclosure, the method may further include transforming a speech signal input through a microphone into the text.

According to various embodiments of the present disclosure, the method may further include analyzing the text to recognize at least one piece of intention information, wherein the reference information is information corresponding to the item related to the recognized intention information, or information corresponding to the category of the recognized named entity.

According to various embodiments of the present disclosure, the determining of the similarity may include: normalizing the named entity into a unit pronunciation row; normalizing at least one piece of the reference information into a unit pronunciation row; and comparing a distance between the normalized named entity and the normalized reference information.

According to various embodiments of the present disclosure, the reference information may be call log information stored in the electronic device.

According to various embodiments of the present disclosure, the method may further include renewing the reference value, based on the user's reaction to the predetermined function.

According to various embodiments of the present disclosure, the renewing of the reference value may include increasing or decreasing a previously configured reference value by a predetermined unit.

According to various embodiments of the present disclosure, the predetermined unit is determined according to at least one of using time, the frequency of use, or the number of pieces of the selected reference information.

According to various embodiments of the present disclosure, the method may further include creating a pronunciation transformation rule, based on the user's reaction to the predetermined function.

According to various embodiments of the present disclosure, the created pronunciation transformation rule may be applied to the determination of the similarity.

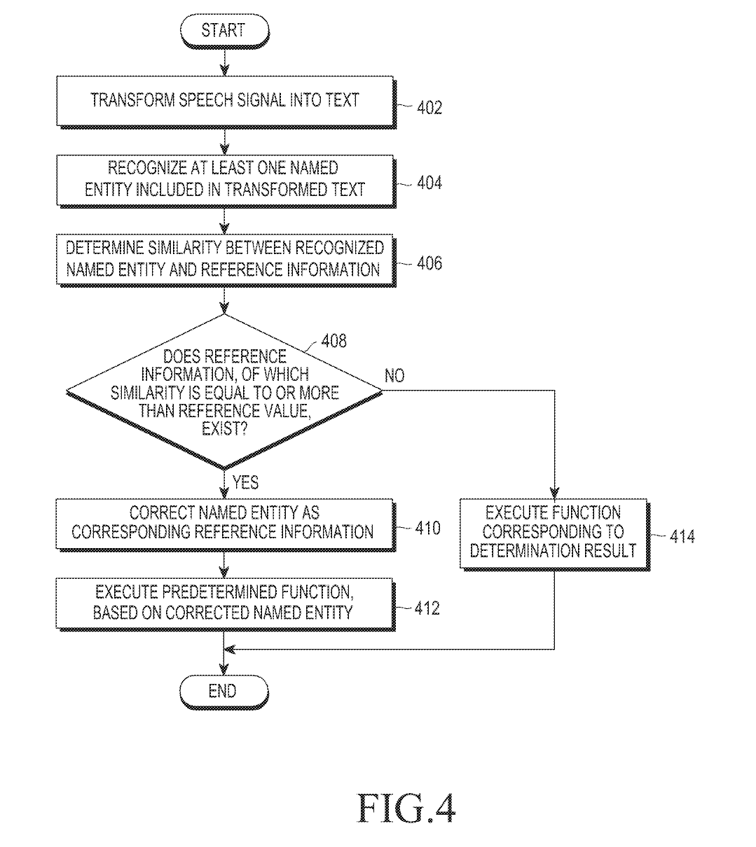

FIG. 4 is a flowchart illustrating an operation of recognizing named entities in an electronic device according to various embodiments of the present disclosure.

Referring to FIG. 4, when a speech signal is input into the electronic device 101 through the microphone, in operation 402, the electronic device 101 may transform the received speech signal into text. The transformation from the speech signal into the text may be conducted using various algorithms.

In operation 404, the electronic device 101 may phrase-analyze the transformed text in order to thereby recognize at least one named entity included in the text. In operation 406, the electronic device 101 may compare the at least one recognized named entity with at least one piece of reference information to thereby determine the similarity.

In operation 408, as a result of comparing the recognized named entity with the at least one piece of the reference information, if the reference information, of which the similarity is greater than or equal to a reference value, exists, the electronic device 101 may correct the corresponding named entity as the at least one piece of reference information in operation 410. In operation 412, the electronic device 101 may execute a predetermined function, based on the selected reference information. In addition, according to various embodiments of the present disclosure, the electronic device may create at least one parameter necessary for the execution of the function, based on the corrected named entity.

In operation 408, as a result of comparing the recognized named entity with the at least one piece of the reference information, if the reference information, of which the similarity is greater than or equal to the reference value, does not exist, the electronic device may execute a function corresponding to the result of the determination in operation 414. For example, the electronic device 101 may execute a predetermined function, based on the named entity recognized in operation 404, or may display a message stating that the function corresponding to the recognized named entity is not executable.

At least one of the operations illustrated in FIG. 4 may be omitted, or at least one other operation may be added between the operations. In addition, the operations may be sequentially processed as illustrated in FIG. 4, and the execution sequence of at least one operation may be switched with that of another operation. Furthermore, the operations illustrated in FIG. 4 may be performed in the electronic device 101 or a server 106. At least one of the operations illustrated in FIG. 4 may be performed within the electronic device 101 and the remaining operations may be performed by the server 106.

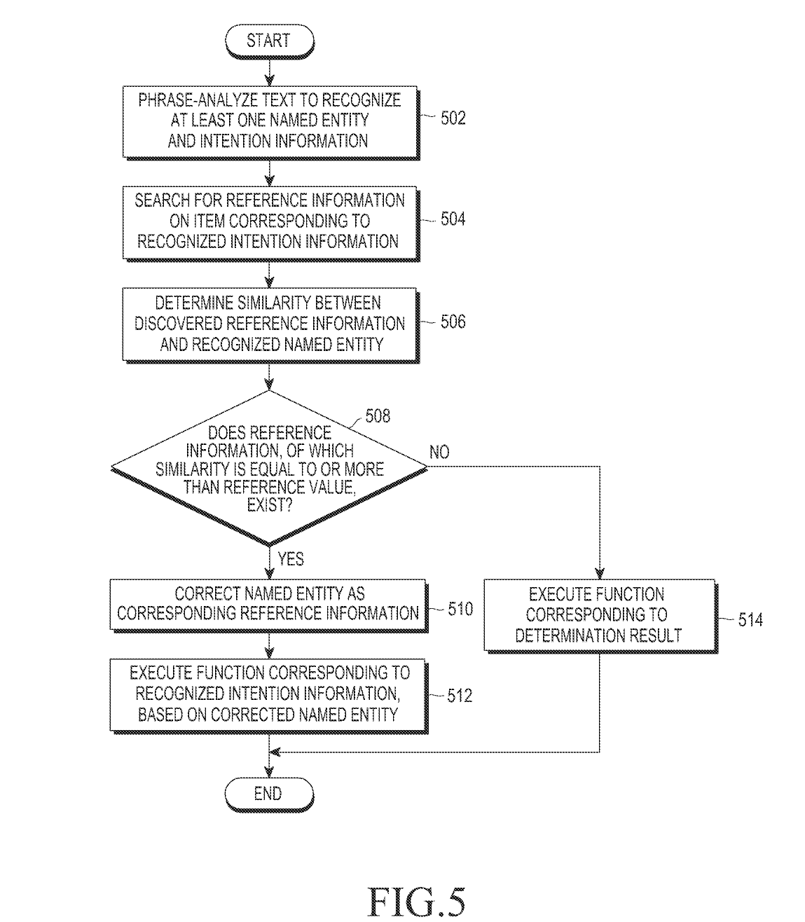

FIG. 5 is a flowchart illustrating an operation of recognizing named entities in an electronic device according to various embodiments of the present disclosure.

Referring to FIG. 5, in operation 502, the electronic device 101 may phrase-analyze the text (e.g., the text pre-stored in the memory, the text that is transformed from a speech signal input through the microphone, or the text input through an input unit (e.g., a touch pad, a touch screen, or a keyboard) by the user) to recognize at least one named entity and intention information, which are include in the text.

In operation 504, the electronic device 101 may search for at least one piece of reference information with respect to the item corresponding to the recognized intention information.

In operation 506, the electronic device 101 may compare the discovered reference information with the recognized named entity to thereby determine the similarity.

In operation 508, as a result of comparing the recognized named entity with the at least one piece of the reference information, if the reference information, of which the similarity is greater than or equal to a reference value, exists, the electronic device 101 may correct the corresponding named entity as the at least one piece of reference information in operation 510. In operation 512, the electronic device 101 may execute a predetermined function corresponding to the intention information recognized in operation 502, based on the corrected named entity.

In operation 508, as a result of comparing the recognized named entity with the at least one piece of the reference information, if the reference information, of which the similarity is greater than or equal to the reference value, does not exist, the electronic device 101 may execute a function corresponding to the result of the determination in operation 514. For example, the electronic device 101 may execute a predetermined function, based on the named entity recognized in operation 502, or may display a message stating that the function corresponding to the recognized named entity is not executable.

At least one of the operations illustrated in FIG. 5 may be omitted, or at least one other operation may be added between the operations. In addition, the operations may be sequentially processed as illustrated in FIG. 5, and the execution sequence of at least one operation may be switched with that of another operation. Furthermore, the operations illustrated in FIG. 5 may be performed in the electronic device 101 or a server 106. At least one of the operations illustrated in FIG. 5 may be performed within the electronic device 101 and the remaining operations may be performed by the server 106.

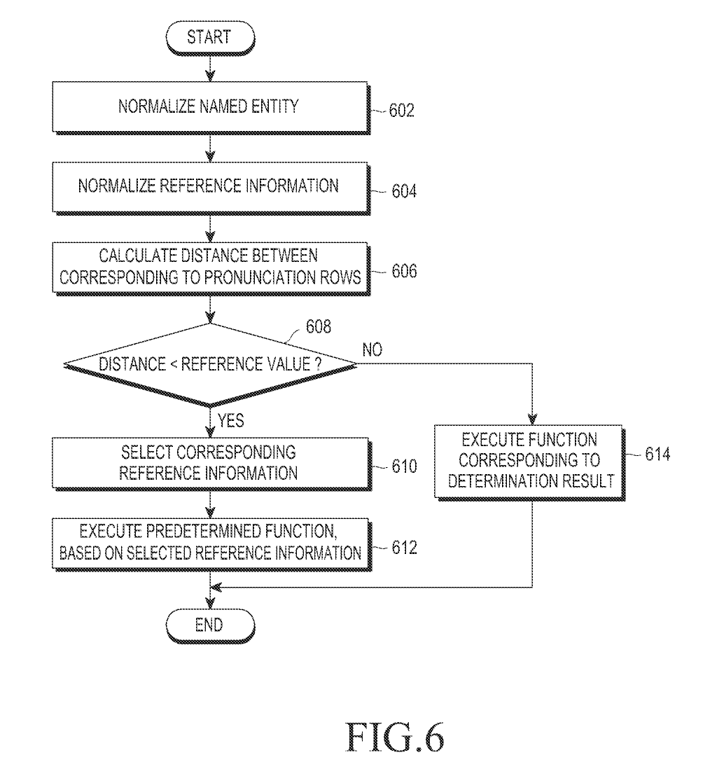

FIG. 6 is a flowchart illustrating an operation of recognizing named entities in an electronic device according to various embodiments of the present disclosure.

Referring to FIG. 6, in operation 602, the electronic device 101 may text-normalize at least one named entity recognized from the text, according to the embodiments set forth above. The normalization of the named entity may include transforming the text into a unit pronunciation row. The unit of the pronunciation row may be a phoneme.

In operation 604, the electronic device 101 may text-normalize at least one piece of reference information pre-stored in the electronic device, or at least one piece of reference information received from the server 106 (which may be referred to as a “comparison candidate group” for convenience of explanation). The normalization of the reference information may include transforming the text into a unit pronunciation row. The unit of the pronunciation row may be a phoneme.

In operation 606, the electronic device 101 may compare the unit pronunciation row corresponding to the named entity with the unit pronunciation row corresponding to the reference information to thereby calculate a distance between the unit pronunciation rows. The calculation of the distance between the unit pronunciation rows may be conducted using, for example, the “Levenshtein distance” method.

In operation 608, as a result of the comparison, if the distance between the unit pronunciation rows is less than (or, equal to or less than) a reference value, the electronic device 101 may select the corresponding reference information in operation 610. In operation 612, the electronic device 101 may execute a predetermined function, based on the selected reference information. According to various embodiments of the present disclosure, in the case of a plurality of pieces of reference information of which the distance between the unit pronunciation rows is less than the reference value, the electronic device 101 may be implemented to receive an additional input for selecting specific reference information from the user.

In operation 608, as a result of the comparison, if the reference information, of which the distance between the unit pronunciation rows is less than the reference value, does not exist, the electronic device 101 may execute a function corresponding to the determination result in operation 614. For example, the electronic device 101 may execute a predetermined function, based on the corresponding named entity, or may display a message stating that the function corresponding to the recognized named entity is not executable.

At least one of the operations illustrated in FIG. 6 may be omitted, or at least one other operation may be added between the operations. In addition, the operations may be sequentially processed as illustrated in FIG. 6, and the execution sequence of at least one operation may be switched with that of another operation. Furthermore, the operations illustrated in FIG. 6 may be performed in the electronic device 101 or a server 106. At least one of the operations illustrated in FIG. 6 may be performed within the electronic device 101 and the remaining operations may be performed by the server 106.

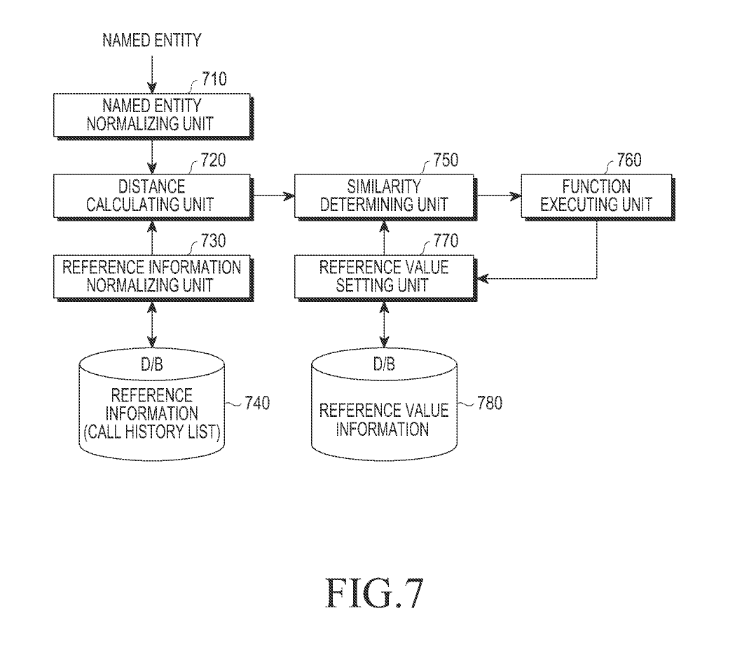

FIG. 7 illustrates a functional block diagram of an electronic device according to various embodiments of the present disclosure.

Referring to FIG. 7, the electronic device 101, according to various embodiments of the present disclosure, may include at least one of a named entity normalizing unit 710, a distance calculating unit 720, a reference information normalizing unit 730, a similarity determining unit 750, a function executing unit 760, or a reference value setting unit 770. At least one of the elements above may be implemented in the natural language recognition module 180 or the processor 120 of FIG. 1. In addition, the electronic device 101, according to various embodiments of the present disclosure, may further include at least one of a reference information database 740, or a reference value information database 780. The databases may be stored in the memory 130 of FIG. 1, or a memory that is not shown here. In addition, the database is not limited to a specific format of a database, and it is enough to structuralize a plurality of pieces of data and to store the same.

The named entity normalizing unit 710 may perform the normalization of the named entity recognized from the text. The reference information normalizing unit 730 may perform the normalization of at least one piece of reference information stored in the reference information database 740. According to various embodiments of the present disclosure, the reference information may be classified according to a category or an item to then be stored, and when the intention information is recognized as a result of the phrase-analyzing of the text, at least one piece of reference information corresponding to the category or the item, which are related to the intention information, may be normalized. For example, as a result of the phrase-analyzing of the text, if “Call” is recognized as the intention information, the reference information corresponding to the call log information (or the call list information) may be normalized as the item related to the intention information.

The distance calculating unit 720 may compare the unit pronunciation row corresponding to the named entity with the unit pronunciation row corresponding to the reference information in order to thereby calculate the distance between the unit pronunciation rows. The calculation of the distance between the unit pronunciation rows may be conducted using, for example, the “Levenshtein distance” method.

The similarity determining unit 750 may determine the similarity according to the calculated distance between the unit pronunciation rows. In addition, in determining the similarity, the similarity determining unit 750 may determine whether or not the distance between the unit pronunciation rows is less than a reference value with reference to reference value setting information of the reference value setting unit 770.

The function executing unit 760 may execute a predetermined function according to the result of the determination by the similarity determining unit 750. For example, as a result of the determination of the similarity determining unit 750, if the distance between the unit pronunciation rows is less than (or, equal to or less than) a reference value, the function executing unit 760 may select the corresponding reference information, and may execute a predetermined function, based on the selected reference information. In addition, as a result of the determination of the similarity determining unit 750, if the reference information, of which the distance between the unit pronunciation rows is less than the reference value, does not exist, the function executing unit 760 may execute a predetermined function, based on the corresponding named entity, or may display a message stating that the function corresponding to the recognized named entity is not executable.

According to various embodiments of the present disclosure, the reference value setting unit 770 may renew the reference value to be used in the next determination of the similarity, according to the determination result of the similarity determining unit 750. For example, the similarity determining unit 750 may compare the distance d(i) (“i” is an index value of at least one piece of reference information to be compared with the named entity) calculated by the distance calculating unit 720 with the reference value T, and the reference value may be renewed according to the determination result of the similarity determining unit 750 as Equation 1 below.

T=(1−α)×T_{P}+α×med(d(i)) Equation 1

In Equation 1, T_{P} denotes the reference value that has been used in the previous determination, or a constant value that is basically configured. In addition, a is a weight value between 0 and 1. In addition, “med( )” is a median filter that means a median value of the distance values with respect to the distributed unit pronunciation rows in calculating the same. According to various embodiments of the present disclosure, “med( )” may be replaced with various statistical values (e.g., an average value) rather than the median value.

The reference value setting unit 770 may correct the reference value according to the previous similarity-determination result to thereby improve the accuracy of the named entity recognition.

In addition, according to various embodiments of the present disclosure, the reference value may be corrected based on the user's reaction to the function executed by the function executing unit 760. For example, in the case where the user uses the function executed by the function executing unit 760, the reference value setting unit 770 may increase the configured reference value. On the contrary, in the case where the user does not use or cancels the function executed by the function executing unit 760, the reference value setting unit 770 may decrease the configured reference value. For example, the reference value may be renewed according to Equation 2 below.

T=T_{P}+Δ Equation 2

In Equation 2, T_{P} denotes the reference value that has been used in the previous determination, or a constant value that is basically configured.

In addition, Δ means the amount of increase or decrease in the reference value. The amount of increase or decrease in the reference value may be configured as a constant value, or may be configured as varying with the using time, the frequency of use, or the number of selected text candidates (the number of pieces of reference information), according to various embodiments of the present disclosure.

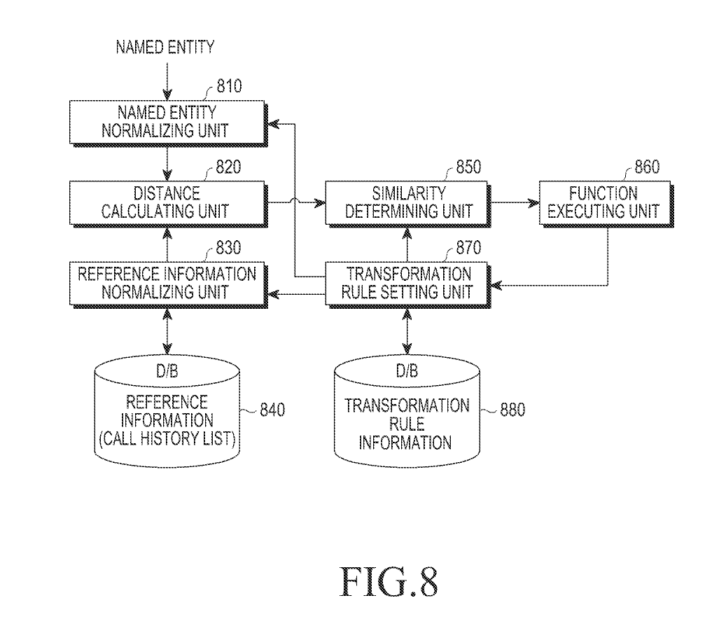

FIG. 8 illustrates a functional block diagram of an electronic device according to various embodiments of the present disclosure.

Referring to FIG. 8, the electronic device 101, according to various embodiments of the present disclosure, may include at least one of a named entity normalizing unit 810, a distance calculating unit 820, a reference information normalizing unit 830, a similarity determining unit 850, a function executing unit 860, or a transformation rule setting unit 870. At least one of the elements above may be implemented in the natural language recognition module 180 or the processor 120 of FIG. 1. In addition, the electronic device 101, according to various embodiments of the present disclosure, may further include at least one of a reference information database 840, or a transformation rule information database 880. The databases may be stored in the memory 130 of FIG. 1, or a memory that is not shown here. In addition, the database is not limited to a specific format of a database, and it is enough to structuralize a plurality of pieces of data and to store the same.

The named entity normalizing unit 810 may perform the normalization of the named entity recognized from the text. The reference information normalizing unit 830 may perform the normalization of at least one piece of reference information stored in the reference information database 840. According to various embodiments of the present disclosure, the reference information may be classified according to a category or an item to then be stored, and when the intention information is recognized as a result of phrase-analyzing the text, at least one piece of reference information corresponding to the category or the item, which are related to the intention information, may be normalized. For example, as a result of the phrase-analyzing of the text, if “Call” is recognized as the intention information, the reference information corresponding to the call log information (or the call list information) may be normalized as the item related to the intention information.

The distance calculating unit 820 may compare the unit pronunciation row corresponding to the named entity with the unit pronunciation row corresponding to the reference information in order to thereby calculate the distance between the unit pronunciation rows. The calculation of the distance between the unit pronunciation rows may be conducted using, for example, the “Levenshtein distance” method.

The similarity determining unit 850 may determine the similarity according to the calculated distance between the unit pronunciation rows. In addition, the similarity determining unit 850 may determine whether or not the distance between the unit pronunciation rows is less than a reference value with reference to reference value setting information to thereby determine the similarity.

The function executing unit 860 may perform a predetermined function according to the result of the determination by the similarity determining unit 850. For example, as a result of the determination of the similarity determining unit 850, if the distance between the unit pronunciation rows is less than (or, equal to or less than) a reference value, the function executing unit 860 may select the corresponding reference information, and may execute a predetermined function, based on the selected reference information. In addition, as a result of the determination of the similarity determining unit 850, if the reference information, of which the distance between the unit pronunciation rows is less than the reference value, does not exist, the function executing unit 860 may execute a predetermined function, based on the corresponding named entity, or may display a message stating that the function corresponding to the recognized named entity is not executable.

According to various embodiments of the present disclosure, the transformation rule setting unit 870 may set at least one transformation rule, based on the user's reaction to the function executed by the function executing unit 860. The transformation rule set by the transformation rule setting unit 870 may be stored in the transformation rule information database 880. In addition, according to various embodiments of the present disclosure, the set transformation rule may be applied to the operation of normalizing the named entity by the named entity normalizing unit 810, or the operation of normalizing the reference information by the reference information normalizing unit 830. In addition, the set transformation rule may be applied to the operation of determining the similarity by the similarity determining unit 850 as well.

For example, if the function with respect to the reference information corrected as a result of the similarity determination of the named entity is executed, and if the user selects the executed function, a difference between the unit pronunciation row corresponding to the recognized named entity and the unit pronunciation row corresponding to the reference information may be identified. The transformation rule setting unit 870 may create a rule, based on at least some of the difference between the unit pronunciation rows.

For example, if the unit pronunciation row of the recognized named entity is “Is ah ng g u/”, and the unit pronunciation row of the reference information is “/ss ah ng g u/,” the transformation rule [/s/ [symbol] /ss/] may be created.

More specifically, when the user pronounces “Gang Ssang Gu” to be transformed into the text, and the recognized named entity according thereto is “Gang Ssang Gu,” the recognized “Gang Ssang Gu” may be compared with at least one piece of reference information stored in the reference information database 840.

If the reference information database 840 does not include “Gang SSang Gu,” but include “Gang Sang Gu,” the similarity exceeds a reference value as a result of the similarity determination by the similarity determining unit 850, and the recognized “Gang Ssang Gu” may be corrected as “Gang Sang Gu,” to then execute the function.

As a result of the execution of the function, if the user selects or approves the function executed according to the corrected “Gang Sang Gu,” the transformation rule may be created such that “s” and “ss” are regarded as the same or similar pronunciation, based on the executed function. According to this, the transformation rule may be applied according to the user's pronunciation in order to thereby correct the named entity to conform to the user's intention so that the recognition rate of the named entity may be improved.

In addition, according to various embodiments of the present disclosure, the transformation rule may be applied only when specific speech features are detected for a specific period of time. The set transformation rule may be amended or cancelled according to the user's operation or the result of the function execution.

In addition, according to various embodiments of the present disclosure, it may be determined whether or not the named entity or the intention information, which are recognized according to the phrase-analyzing of the text, is related to a specific item, and various services may be provided according thereto. For example, if it is determined that the recognized named entity or intention information is related to a location, the location of the electronic device may be detected. Based on the detected location of the electronic device, location-related information around the electronic device may be collected.

The collected location-related information may be used as the reference information (a text candidate group) in the various embodiments set forth above. Accordingly, the recognized named entity may be compared with the collected reference information (e.g., location-related information) for the determination of the similarity in order to thereby enhance the recognition rate of the named entity.

In addition, according to various embodiments of the present disclosure, if the recognized named entity or intention information is related to a company name, company name information may be collected within a predetermined range around the electronic device to then be used as the reference information.

In addition, according to various embodiments of the present disclosure, if the recognized named entity or intention information is related to an address, address information within a predetermined range around the electronic device, among the whole address information, may be used as the reference information.

In addition, according to various embodiments of the present disclosure, if the recognized named entity or intention information is related to a company name, company name information may be collected within a predetermined range around the electronic device to be configured as the reference information, and the company name information stored in a personal address list in the electronic device may be combined with the same to then be configured as the reference information.

In addition, according to various embodiments of the present disclosure, if the recognized named entity or intention information is related to the name of a specific application, the reference information may be configured based on information on the applications installed in the electronic device by the user.

In addition, according to various embodiments of the present disclosure, if the recognized named entity or intention information is related to a company name, the information related to the company name may be collected from a dialogue history made by the user using the electronic device, and the reference information may be configured based on the collected company name-related information.

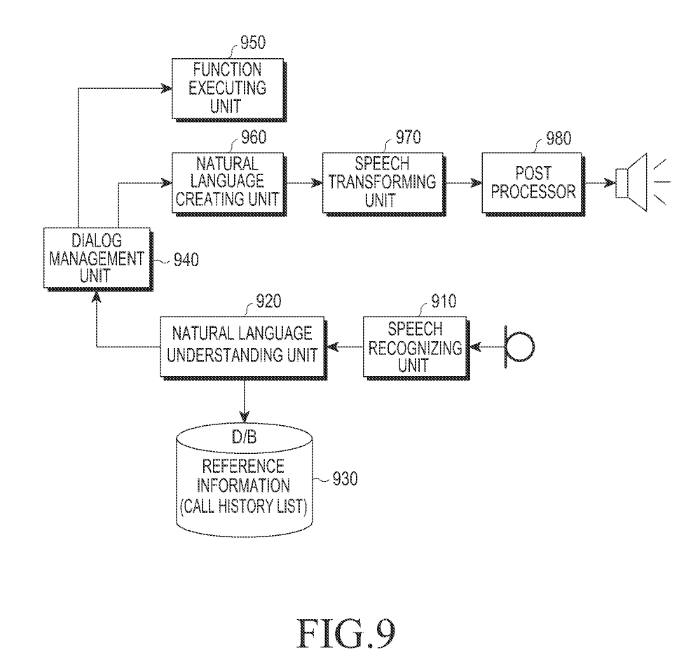

FIG. 9 illustrates a functional block diagram of an electronic device according to various embodiments of the present disclosure.

Referring to FIG. 9, according to various embodiments of the present disclosure, the electronic device 101 may include at least one of a speech recognizing unit 910, a natural language understanding unit 920, a dialogue management unit 940, a function executing unit 950, a natural language creating unit 960, a speech transforming unit 970, or a post processor 980.

The speech recognizing unit 910 may transform a speech signal input through the microphone into text. The speech recognizing unit 910 may transform a speech signal into the text using an automatic speech recognition (ASR) algorithm.

The natural language understanding unit (NLU) 920 may recognize the named entity or the intention information from the text, according to various embodiments of the present disclosure as mentioned above, and may compare the recognized named entity with the reference information stored in a reference information database 930 in order to thereby determine the similarity thereof. The natural language understanding unit 920 may correct the recognized named entity as at least one piece of reference information, according to the determination result of the similarity.

The dialogue management (DM) unit 940 may receive the named entity or the intention information, which is corrected by the natural language understanding unit 920, and may decide a function to be executed or update a system, based on the information.

The function executing unit 950 may execute a function decided by the dialogue management unit 940.

The natural language creating unit 960 may create a natural language for a response in the form of a sentence, according to the determination of the dialogue management unit 940. The speech transforming unit 970 may transform the sentence created by the natural language creating unit 960 into a speech signal. The post processor 980 may process the speech signal to then be output through a speaker.

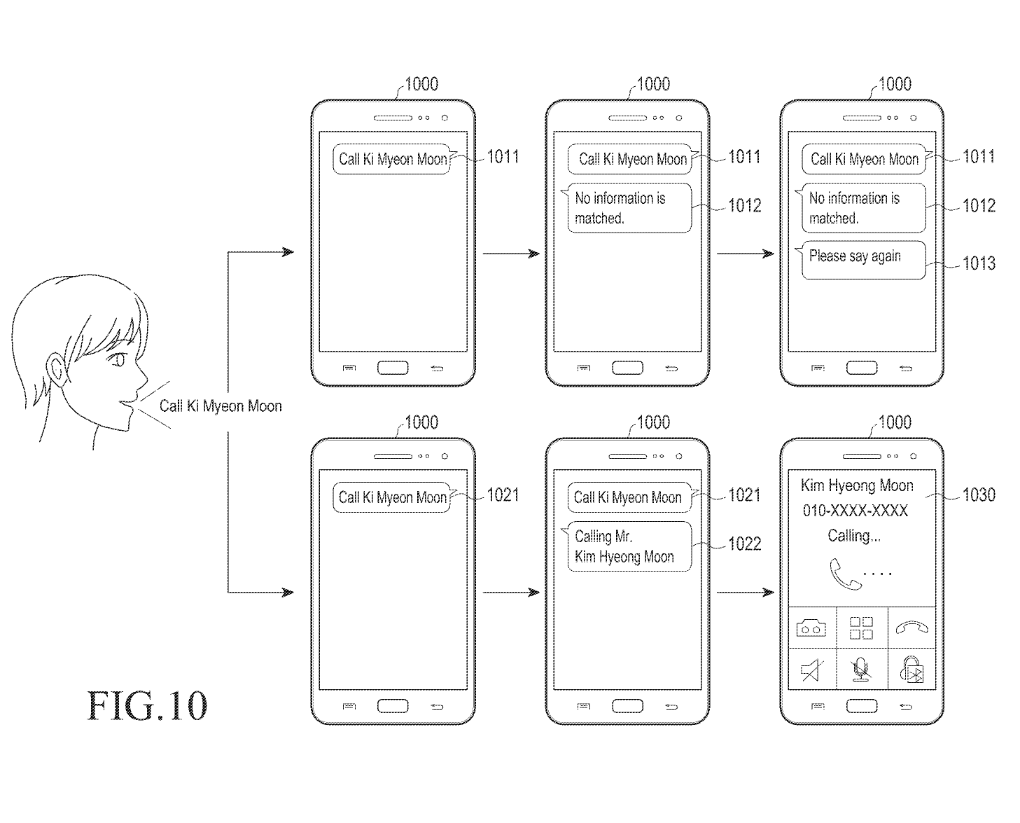

FIG. 10 illustrates an example of processing input speech in an electronic device according to various embodiments of the present disclosure.

Referring to FIG. 10, when the user says “Call Ki Myeon Moon” through the microphone of the electronic device 1000, the speech signal may be input through the microphone of the electronic device 1000.

The speech signal input into the electronic device 1000 may be transformed into the text “Call Ki Myeon Moon” through the speech recognition unit. The transformed text 1011 or 1021 may be displayed on the display.

In the case where the similarity determination with respect to the transformed text using the reference information is not applied, since the person in the name of “Ki Myeon Moon” is not recorded in the contact list, as shown in the upper diagram of FIG. 10, the message 1012 “No information is matched” may be displayed on the display. In addition, the message 1013 “Please say again” may be displayed in order to allow the user to input the speech signal again.

When, according to various embodiments of the present disclosure, in the case where the similarity determination with respect to the transformed text using the reference information is applied, even though the person in the name of “Ki Myeon Moon” is not recorded in the contact list, the named entity “Ki Myeon Moon” may be compared with at least one piece of reference information stored in the reference information database (e.g., the call log) or the contact list. As a result of the comparison, if “Kim Hyeong Moon” is determined as the reference information that has a similarity greater than or equal to a reference value, “Ki Myeon Moon” may be corrected as “Kim Hyeong Moon” to then execute a function corresponding thereto.

For example, the electronic device 1000 may recognize the named entity “Ki Myeon Moon” from the text “Call Ki Myeon Moon,” and may recognize “Call” as the intention information. Then, the electronic device 1000 may correct “Ki Myeon Moon” as “Kim Hyeong Moon” to thereby perform the call function. For example, as shown in the lower diagram of FIG. 10, the electronic device 1000 may display the message 1022 “Calling Mr. Kim Hyeong Moon,” and may make a call to “Kim Hyeong Moon” (see 1030).

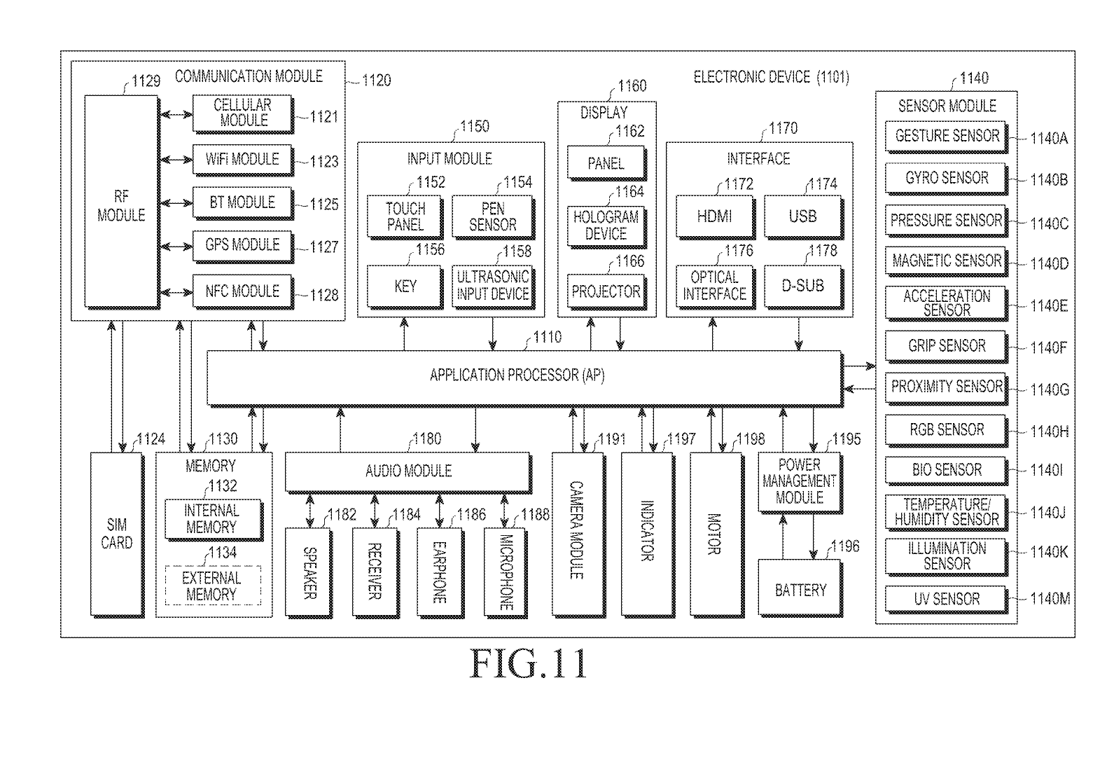

FIG. 11 is a block diagram of an electronic device according to various embodiments of the present disclosure.

Referring to FIG. 11, an electronic device 1101, for example, may include a part of or all of the electronic device 101 shown in FIG. 1. The electronic device 1101 may include one or more APs 1110, a communication module 1120, a subscriber identification module (SIM) card 1124, a memory 1130, a sensor module 1140, an input device 1150, a display module 1160, an interface 1170, an audio module 1180, a camera module 1191, a power management module 1195, a battery 1196, an indicator 1197, and a motor 1198.

The AP 1110, for example, may control a multitude of hardware or software elements connected with the AP 1110 and perform the processing of data and the calculation, by driving an operating system or application programs. The AP 1110 may be implemented with, for example, a system on chip (SoC). According to an embodiment of the present disclosure, the AP 1110 may further include a graphics processing unit (GPU) and/or an image signal processor. The AP 1110 may include at least some (e.g., a cellular module 1121) of the elements shown in FIG. 11. The AP 1110 may load and process instructions or data received from at least one of other elements (e.g., a non-volatile memory), and may store various pieces of data in the non-volatile memory.

The communication module 1120 may have the identical or similar elements to the communication interface 160 of FIG. 1. The communication module 1120, for example, may include a cellular module 1121, a Wi-Fi module 1123, a Bluetooth (BT) module 1125, a GPS module 1127, a near field communication (NFC) module 1128, or a radio frequency (RF) module 1129.

The cellular module 1121, for example, may provide services of a voice call, a video call and text messaging, or an Internet service through communication networks. According to an embodiment of the present disclosure, the cellular module 1121 may perform identification and authentication of the electronic device 1101 in the communication network by using a SIM (e.g., the SIM card 1124). According to an embodiment of the present disclosure, the cellular module 1121 may perform at least some of the functions provided by the AP 1110. According to an embodiment of the present disclosure, the cellular module 1121 may include a CP.

Each of the Wi-Fi module 1123, the BT module 1125, the GPS module 1127, or the NFC module 1128 may include, for example, a processor for processing data transmitted and received through the corresponding module. According to an embodiment of the present disclosure, at least some (e.g., two or more) of the cellular module 1121, the Wi-Fi module 1123, the BT module 1125, the GPS module 1127, or the NFC module 1128 may be included in one integrated chip (IC) or in one IC package.

The RF module 1129 may transmit and receive communication signals (e.g., RF signals). The RF module 1129 may include, for example, a transceiver, a power amp module (PAM), a frequency filter, a low noise amplifier (LNA), an antenna, or the like. According to an embodiment of the present disclosure, at least one of the cellular module 1121, the Wi-Fi module 1123, the BT module 1125, the GPS module 1127, or the NFC module 1128 may transmit and receive RF signals through a separate RF module.

The SIM cards 1124, for example, may include a card adopting a SIM and/or an embedded SIM, and may include an inherent identification information (e.g., an integrated circuit card identifier (ICCID)) or subscriber information (e.g., an international mobile subscriber identity (IMSI)).

The memory 1130 (e.g., the memory 130), for example, may include an internal memory 1132 or an external memory 1134. The internal memory 1132, for example, may include at least one of a volatile memory (e.g., a dynamic random access memory (DRAM), a static RAM (SRAM), a synchronous DRAM (SDRAM), or the like) or a non-volatile memory (e.g., an one time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash, or a NOR flash), or the like), a hard drive, or a solid state drive (SSD).

The external memory 1134 may further include a flash drive, for example, a compact flash (CF), a secure digital (SD), a micro-SD, a mini-SD, an extreme digital (xD), a memory stick, or the like. The external memory 1134 may be functionally and/or physically connected with the electronic device 1101 through various interfaces.

The sensor module 1140, for example, may measure physical quantities and detect an operation state of the electronic device 1101, to thereby convert the measured or detected information to electric signals. The sensor module 1140 may include at least one of, for example, a gesture sensor 1140A, a gyro-sensor 1140B, an atmospheric sensor 1140C, a magnetic sensor 1140D, an acceleration sensor 1140E, a grip sensor 1140F, a proximity sensor 1140G, a color sensor 1140H (e.g., a red-green-blue (RGB) sensor), a bio sensor 1140I, a temperature/humidity sensor 1140J, an illuminance sensor 1140K, or an ultra violet (UV) sensor 1140M. Alternatively or additionally, the sensor module 1140 may further include, for example, an E-nose sensor, an electromyography sensor (EMG), an electroencephalogram sensor (EEG), an electrocardiogram sensor (ECG), an infrared (IR) sensor, an iris sensor, and/or a fingerprint sensor, or the like. The sensor module 1140 may further include a control circuit for controlling at least one sensor included therein. In an embodiment of the present disclosure, the electronic device 1101 may further a processor to control the sensor module 1140 as a part of the AP 1110 or separately from the AP 1110 in order to thereby control the sensor module 1140 while the AP 1110 is in a sleep mode.

The input device 1150, for example, may include a touch panel 1152, a (digital) pen sensor 1154, keys 1156, or an ultrasonic input device 1158. The touch panel 1152 may detect a touch input in at least one of, for example, a capacitive type, a pressure type, an infrared type, or an ultrasonic type. In addition, the touch panel 1152 may further include a control circuit. The touch panel 1152 may further include a tactile layer to provide a user with a tactile reaction.

The (digital) pen sensor 1154, for example, may be a part of the touch panel, or may include a separate recognition sheet. The keys 1156 may include, for example, physical buttons, optical keys, or a keypad. The ultrasonic input device 1158 detects acoustic waves with a microphone (e.g., the microphone 1188) in the electronic device 1101 through an input means that generates ultrasonic signals to thereby identify data.

The display 1160 (e.g., the display 160) may include a panel 1162, a hologram device 1164, or a projector 1166. The panel 1162 may include the identical or similar elements to the display 160 of FIG. 1. The panel 1162 may be implemented to be, for example, flexible, transparent or wearable. The panel 1162 may be configured with the touch panel 1152 as a single module. The hologram device 1164 may display three-dimensional (3D) images in the air by using interference of light. The projector 1166 may display images by projecting light onto a screen. The screen may be provided, for example, inside or outside the electronic device 1101. According to an embodiment, the display 1160 may further include a control circuit for controlling the panel 1162, the hologram device 1164, or the projector 1166.

The interface 1170 may include, for example, an HDMI 1172, a USB 1174, an optical interface 1176, or a D-subminiature (D-sub) 1178. The interface 1170 may be included in, for example, the communication interface 160 shown in FIG. 1. Additionally or alternatively, the interface 1170 may include, for example, a mobile high-definition link (MHL) interface, an SD card/multi-media card (MMC) interface, or an infrared data association (IrDA) standard interface.

The audio module 1180 may convert a sound into an electric signal, and vice versa. At least some elements of the audio module 1180 may be included in, for example, the input/output interface 150 shown in FIG. 1. For example, the audio module 1180 may process voice information input or output through a speaker 1182, a receiver 1184, earphones 1186 or a microphone 1188.

The camera module 1191 is a device for photographing still and moving images, and, according to an embodiment of the present disclosure, may include at least one image sensor (e.g., a front sensor or a rear sensor), lenses, an image signal processor (ISP), or a flash (e.g., LED or a xenon lamp).

The power control module 1195, for example, may manage power of the electronic device 1101. According to an embodiment of the present disclosure, the power management module 1195 may include, for example, a power management integrated circuit (PMIC), a charger IC, or a battery or fuel gauge. The PMIC may be implemented in a wired and/or wireless charging type. The wireless charging type may encompass, for example, a magnetic resonance type, a magnetic induction type or an electromagnetic wave type, and additional circuits for wireless charging, for example, coil loops, resonance circuits, rectifiers, or the like, may be further provided. The battery gauge may measure, for example, the remaining power of the battery 1196, a charging voltage and current, or temperature. The battery 1196 may include, for example, a rechargeable battery or a solar battery.

The indicator 1197 may display a specific state, for example, a booting state, a message state, or a charging state of the whole or a part (e.g., the AP 1110) of the electronic device 1101. The motor 1198 may convert an electric signal to a mechanical vibration, and may provide a vibration effect or a haptic effect. Although not shown, the electronic device 1101 may include a processing device (e.g., the GPU) for supporting mobile TV. The processing device for supporting mobile TV may process media data according to the standard such as, for example, digital multimedia broadcasting (DMB), digital video broadcasting (DVB) or media flow.

Each of the components of the electronic device according to the present disclosure may be implemented by one or more components and the name of the corresponding component may vary depending on a type of the electronic device. In various embodiments, the electronic device may include at least one of the above-described elements. Some of the above-described elements may be omitted from the electronic device, or the electronic device may further include additional elements. Further, some of the elements of the electronic device according to various embodiments of the present disclosure may be coupled to form a single entity while performing the same functions as those of the corresponding elements before the coupling.

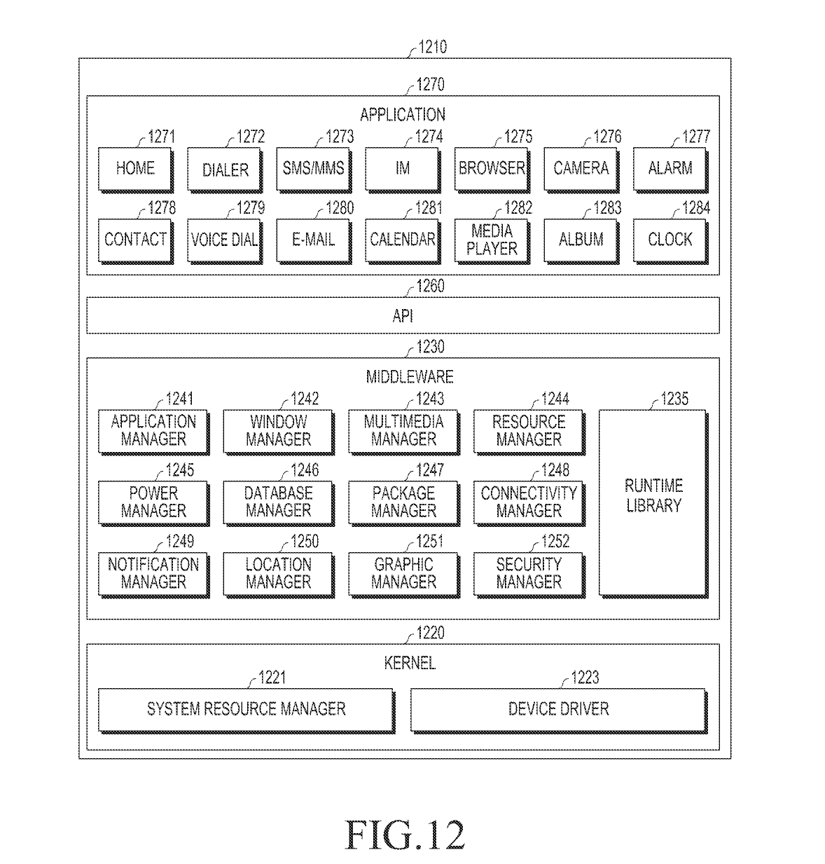

FIG. 12 is a block diagram of a program module according to various embodiments of the present disclosure.

Referring to FIG. 12, according to an embodiment of the present disclosure, programming modules 1210 (e.g., the programs 140) may include an OS for controlling resources related to the electronic device (e.g., the electronic device 101), and/or various applications (e.g., application programs 147) performed under the operating system. For example, the operating system may be Android, iOS, Windows, Symbian, Tizen, Bada, or the like.

The programming module 1210 may include a kernel 1220, a middleware 1230, an API 1260, and/or applications 1270. At least a part of the program module 1210 may be preloaded, or may be downloaded from the server (e.g., the server 106).

The kernel 1220 (e.g., the kernel 141 of FIG. 1), for example, may include a system resource manager 1221 or a device driver 1223. The system resource manager 1221 may perform the control, allocation or collection of the system resources. According to an embodiment of the present disclosure, the system resource manager 1221 may include a process management unit, a memory management unit, or a file system management unit. The device driver 1223 may include, for example, a display driver, a camera driver, a BT driver, a common memory driver, a USB driver, a keypad driver, a Wi-Fi driver, an audio driver, or an inter-process communication (IPC) driver.

The middleware 1230, for example, may provide functions required in common for the applications 1270, or may provide various functions to the applications 1270 through the API 1260 in order to allow the applications 1270 to effectively use limited system resources in the electronic device. According to an embodiment of the present disclosure, the middleware 1230 (e.g., the middleware 143) may include at least one of a run time library 1235, an application manager 1241, a window manager 1242, a multimedia manager 1243, a resource manager 1244, a power manager 1245, a database manager 1246, a package manager 1247, a connectivity manager 1248, a notification manager 1249, a location manager 1250, a graphic manager 1251, or security manager 1252.

The run time library 1235 may include a library module that, for example, a compiler uses in order to add new functions through programming language while the applications 1270 are in progress. The run time library 1235 may perform functions, such as managing of an input/output, managing of a memory, or arithmetic calculation.

The application manager 1241 may manage, for example, a life cycle of at least one application among the applications 1270. The window manager 1242 may manage a graphical user interface (GUI) resource used in a screen. The multimedia manager 1243 may identify formats for reproducing various media files, and may perform encoding or decoding of media files by using a codec corresponding to each format. The resource manager 1244 may manage resources such as a source code, a memory, or a storage space of at least one application among the applications 1270.

The power manager 1245, for example, may manage a battery or power in interwork with a basic input/output system (BIOS), and provide power information necessary for the operation thereof. The database manager 1246 may manage to create, search for or change data that is to be used in at least one of the applications 1270. The package manager 1247 may manage the installation or the updating of applications distributed in the form of a package file.

The connectivity manager 1248 may manage a wireless connection, such as, for example, Wi-Fi or BT. The notification manager 1249 may display or notify events, such as received messages, appointments, and proximity notifications to a user without disturbance. The location manager 1250 may manage location information of the electronic device. The graphic manager 1251 may manage graphic effects to be provided to a user, or a user interface related thereto. The security manager 1252 may provide a general security function required for system security or user authentication. According to an embodiment of the present disclosure, when the electronic device (e.g., the electronic device 101) adopts a phone call function, the middleware 1230 may further include a telephony manager for managing functions of a voice call or a video call of the electronic device.

The middleware 1230 may include a new middleware module through a combination of various functions of the elements set forth above. The middleware 1230 may provide a module that is specialized according to the type of operating system in order to provide differentiated functions. In addition, some typical elements may be dynamically removed from the middleware 1230, or new elements may be added to the middleware 1230.

The API 1260 (e.g., the API 145) may be provided as a group of API programming functions, and may be provided with a different configuration according to an operating system. For example, one set of APIs may be provided to each platform in the case of Android or iOS, and at least two sets of APIs may be provided to each platform in the case of Tizen.

The applications 1270 (e.g., the application programs 147), for example, may include a home application 1271, a dialer application 1272, a short message service (SMS)/multimedia message service (MMS) application 1273, an instant messaging (IM) application 1274, a browser application 1275, a camera application 1276, an alarm application 1277, a contact application 1278, a voice dial application 1279, an e-mail application 1280, a calendar application 1281, a media player application 1282, an album application 1283, a clock application 1284, a healthcare program (e.g., an application for measuring the amount of exercise or blood sugar), an environmental information providing application (e.g., an application for providing atmospheric pressure, humidity, or temperature information), or the like.

According to an embodiment of the present disclosure, the applications 1270 may include an application (hereinafter, referred to as an “information-exchange-related application”) that supports the exchange of information between the electronic device (e.g., the electronic device 101) and external electronic devices (e.g., the external electronic devices 102 and 104). The information-exchange-related application may include, for example, a notification relay application for relaying specific information to the external electronic device, or a device management application for managing the external electronic device.

For example, the notification relay application may include a function of transferring notification information generated in other applications (e.g., the SMS/MMS application, the e-mail application, the healthcare application, or the environmental information providing application) of the electronic device to the external electronic devices (e.g., the external electronic devices 102 and 104). In addition, the notification relay application may receive notification information from, for example, the external electronic devices and provide the same to a user. The device management application may manage (e.g., install, delete, or update), for example, at least some functions (e.g., turning on or off the external electronic device (or some elements thereof), or adjusting the brightness (or resolution) of a display) of external electronic device (e.g., the electronic device 104) that communicates with the electronic device, applications performed in the external electronic device, or services (e.g., a phone call service, or a messaging service) provided in the external electronic device.

According to an embodiment of the present disclosure, the applications 1270 may include applications (e.g., a healthcare application), which are designated according to the properties (e.g., the type of electronic device is a mobile medical device) of the external electronic device (e.g., the external electronic device 102 or 104). According to an embodiment of the present disclosure, the application 1270 may include at least one of applications received from external electronic devices (e.g., the server 106, or the external electronic devices 102 and 104). According to an embodiment of the present disclosure, the application 1270 may include a preloaded application, or a third-party application that may be downloaded from the server. The names of the elements in the program module 1210, according to the embodiment of the present disclosure illustrated, may vary with the type of operating system.

According to various embodiments of the present disclosure, at least a part of the programming module 1210 may be implemented in software, firmware, hardware, or a combination of two or more thereof. At least some of the programming module 1210 may be implemented (for example, executed) by, for example, the processor (for example, the AP 1110). At least some of the program module 1210 may include, for example, a module, a program, a routine, a set of instructions, and/or a process for performing one or more functions.

The term “module” or “functional unit” used herein may, for example, mean a unit including one of hardware, software, and firmware or a combination of two or more of them. The “module” may be interchangeably used with, for example, the term “unit”, “logic”, “logical block”, “component”, or “circuit”. The “module” or “function unit” may be a minimum unit of an integrated component element or a part thereof. The “module” may be a minimum unit for performing one or more functions or a part thereof. The “module” or “function unit” may be mechanically or electronically implemented. For example, the “module” or “function unit” according to the present disclosure may include at least one of an application-specific IC (ASIC) chip, a field-programmable gate array (FPGA), and a programmable-logic device for performing operations which has been known or are to be developed hereinafter.

According to various embodiments of the present disclosure, at least some of the devices (for example, modules or functions thereof) or the method (for example, operations) according to the present disclosure may be implemented by a command stored in a computer-readable storage medium in a programming module form. When the command is executed by one or more processors (for example, the processor 120), the one or more processors may execute a function corresponding to the command. The computer-readable storage medium may be, for example, the memory 130.

The computer readable recoding medium may include a hard disk, a floppy disk, magnetic media (e.g., a magnetic tape), optical media (e.g., a compact disc ROM (CD-ROM) and a DVD), magneto-optical media (e.g., a floptical disk), a hardware device (e.g., a ROM, a RAM, a flash memory), and the like. In addition, the program instructions may include high class language codes, which may be executed in a computer by using an interpreter, as well as machine codes made by a compiler. Any of the hardware devices as described above may be configured to work as one or more software modules in order to perform the operations according to various embodiments of the present disclosure, and vice versa.

Any of the modules or programming modules according to various embodiments of the present disclosure may include at least one of the above described elements, exclude some of the elements, or further include other additional elements. The operations performed by the modules, programming module, or other elements according to various embodiments of the present disclosure may be executed in a sequential, parallel, repetitive, or heuristic manner. Further, some operations may be executed according to another order or may be omitted, or other operations may be added.

According to various embodiments of the present disclosure, a computer-readable recording medium may record a program including executable instructions to allow at least one processor to execute at least one of the operations of: analyzing text to recognize at least one named entity; comparing the recognized named entity with at least one piece of reference information to determine the similarity; as a result of the determination, selecting at least one piece of reference information of which the similarity with respect to the recognized named entity is greater than or equal to a reference value; and executing a predetermined function, based on the selected reference information.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for operating an electronic device, the method comprising:
analyzing text to recognize at least one named entity;
comparing the recognized named entity with at least one piece of reference information to determine the similarity;
selecting, as a result of the determination, at least one piece of reference information of which the similarity with respect to the recognized at least one named entity is greater than or equal to a reference value; and
executing a predetermined function, based on the selected at least one piece of reference information.

2. The method of claim 1, further comprising:
transforming a speech signal input through a microphone into the text.

3. The method of claim 1, further comprising:
analyzing the text to recognize at least one piece of intention information,
wherein the at least one piece of reference information comprises information corresponding to the item related to the recognized intention information, or information corresponding to the category of the recognized at least one named entity.

4. The method of claim 1, wherein the determining of the similarity comprises:
normalizing the at least one named entity into a unit pronunciation row;
normalizing the at least one piece of the reference information into a unit pronunciation row; and
comparing a distance between the normalized at least one named entity and the normalized at least one piece of reference information.

5. The method of claim 1, wherein the at least one piece of reference information comprises call log information stored in the electronic device.

6. The method of claim 1, further comprising:
renewing the reference value, based on the user's reaction to the predetermined function.

7. The method of claim 6, wherein the renewing of the reference value comprises increasing or decreasing a previously configured reference value by a predetermined unit.

8. The method of claim 7, wherein the predetermined unit is determined according to at least one of using time, the frequency of use, or the number of pieces of the selected at least one piece of reference information.

9. The method of claim 1, further comprising:
creating a pronunciation transformation rule, based on the user's reaction to the predetermined function.

10. The method of claim 9, wherein the created pronunciation transformation rule is applied to the determination of the similarity.

11. An electronic device comprising:
a memory configured to store at least one piece of reference information; and
a controller configured to:
analyze text to recognize at least one named entity,
compare the recognized at least one named entity with at least one piece of reference information to determine the similarity, as a result of the determination,
select at least one piece of reference information of which the similarity with respect to the at least one recognized named entity is greater than or equal to a reference value, and
execute a predetermined function, based on the selected at least one piece of reference information.

12. The electronic device of claim 11, wherein the controller is further configured to make a control to transform a speech signal input through a microphone into text.

13. The electronic device of claim 11,
wherein the controller is further configured to make a control to phrase-analyze the text to thereby recognize at least one piece of intention information, and
wherein the at least one piece of reference information is information corresponding to the item related to the recognized intention information, or information corresponding to the category of the recognized at least one named entity.

14. The electronic device of claim 11, wherein the at least one piece of reference information is call log information stored in the electronic device.

15. The electronic device of claim 11, wherein the controller is further configured to make a control to renew the reference value, based on the user's reaction to the predetermined function.

16. The electronic device of claim 15, wherein the renewing of the reference value comprises increasing or decreasing a previously configured reference value by a predetermined unit.

17. The electronic device of claim 16, wherein the predetermined unit is determined according to at least one of using time, the frequency of use, or the number of pieces of the selected at least one piece of reference information.

18. The electronic device of claim 11, wherein the controller is further configured to make a control to create a pronunciation transformation rule, based on the user's reaction to the predetermined function.

19. The electronic device of claim 18, wherein the created pronunciation transformation rule is applied to the determination of the similarity.

20. The electronic device of claim 11, wherein the similarity is further determined if the distance between unit pronunciation rows is less than or equal to the reference value.

21. A non-transitory computer-readable recording medium that records a program including executable instructions to allow a processor to execute the operations of:
analyzing text to recognize at least one named entity;
comparing the recognized at least one named entity with at least one piece of reference information to determine the similarity; as a result of the determination;
selecting at least one piece of reference information of which the similarity with respect to the recognized at least one named entity is greater than or equal to a reference value; and
executing a predetermined function, based on the selected at least one piece of reference information.
